(19) United States
(12) Patent Application Publication
(10) Pub. No.: US 2002/0150140 A1
(43) Pub. Date: Oct. 17, 2002

(54) Inductively coupled thermistors and other sensors

(76) Inventors: Joseph Julicher, Chandler, AZ (US); Paul N. Katz, Bellaire, TX (US)

Correspondence Address: PAUL N. KATZ, BAKER BOTTS L.L.P., ONE SHELL PLAZA, 901 LOUISIANA STREET, HOUSTON, TX, 77002-4995, US

(21) Appl. No.: 09/780,850

(22) Filed: Feb. 9, 2001

(51) Int. Cl. G01K 1/14; G01K 7/22; G01K 13/00

(52) U.S. Cl. 374/120; 374/183; 374/141

(57) ABSTRACT

Measurement of environment parameters beyond a barrier without having to make a hole in the barrier to connect a sensor to the other circuitry may be made using a primary inductor on one side of the barrier inductively coupled to a secondary inductor on the other side of the barrier. A thermistor or other sensor is connected to the secondary inductor and disposed with the secondary inductor on the other side of the barrier. A pulse generator causes a first current through the primary inductor that is modified by a mutually induced second current through the secondary inductor, that is further determined by the resistance or impedance of the thermistor or sensor. A measuring circuit converts the peak current value into a value representative of the temperature or other environment parameter surrounding the sensor.

### FIELD OF THE INVENTION

This invention relates to circuits for monitoring or measuring temperature and other parameters, and more particularly, to inductively coupled thermistors and other sensors useful for monitoring temperatures and other environment parameters inside refrigerators and other closed or remote environments.

### DESCRIPTION OF THE INVENTION TECHNOLOGY

Thermistors come in a wide variety of shapes and sizes. Most temperature sensing applications use an NTC (negative temperature coefficient) type of thermistor, in which the resistance goes down with increasing temperature. Because the resistance does not go down linearly, some degree of processing is required to translate the resistance to a temperature. This may be accomplished by electronic logic, e.g., a microcontroller. The normal method of interfacing to a thermistor is by incorporating it into a simple voltage divider: a constant voltage supply (e.g., five volts) is connected to a resistor of known value. The resistor is connected to the thermistor and the microcontroller. The thermistor is connected to common. The microcontroller is used to measure the voltage across the thermistor. From this measurement, the resistance value of the thermistor can be derived, using the voltage divider technique.

The foregoing system is inappropriate for a through wall temperature system, because it requires a wire to connect the thermistor to the microcontroller. Also, Direct Current (DC) cannot be transmitted through a wall, so this system cannot be directly converted to a through wall system.

Thermistors are conventionally used inside refrigerators in order to monitor the temperature. These thermistors are typically placed inside the body of the refrigeration unit and are coupled to a circuit lying outside the body of the refrigerator by a wire or similar connector. In order to couple the thermistor to the circuit, a hole must be made through the body of the refrigerator to accommodate the wire connector. This hole through the body reduces the insulation efficiency of the refrigerator and also its structural integrity.

Inductive coupling devices have been used to measure temperature in rotating machines. U.S. Pat. No. 4,105,038 describes a system for transmitting signals between stationary and movable portions of a machine without using a direct electrical connection. However, this system uses a continuous AC signal to transmit power through a transformer. The transformer provides the interface between the stationary and rotating machine parts. The AC signal powers an active circuit that contains a pulse generator and a thermistor that responds to the temperature. Since the phase of the resulting pulses varies with temperature, a temperature value may be derived from a phase measurement. Unlike the present invention, this system uses continuous power transfer to power an active sensor circuit. The pulse generator then actively generates a stream of pulses. The thermistor determines the character of pulses generated. The intelligence is thereby gathered through a continuous stream of pulses. As such, this device has a number of disadvantages, such as the active, complex circuitry connected to the thermistor and the measurement inaccuracy introduced by resistive heating of the thermistor caused by the continuous AC signal.

Inductive coupling has also been used to monitor the state of a first circuit using a second circuit by using an inductive coupling to link the circuits across the gap. U.S. Pat. No. 4,339,714 describes a system in which a frequency shift of an AC signal is used to convey the intelligence. An AC signal is continuously supplied by the second circuit via an inductive or capacitive coupling to the passive first circuit. A change in the impedance of the first circuit will cause frequency variations in the AC signal in the second circuit. This device has a number of disadvantages, such as the complex circuitry connected to the thermistor and the measurement inaccuracy introduced by resistive heating of the thermistor caused by the continuous AC signal.

Inductive coupling has not heretofore been used to precisely monitor temperature in a closed container, such as a refrigerator, or beyond a barrier. Therefore, what is needed is an inexpensive, simple and effective way of measuring temperature in a closed container or beyond a barrier without having to place a hole through the container or barrier.

### SUMMARY OF THE INVENTION

The present invention overcomes the above-identified problems as well as other shortcomings and deficiencies of existing technologies in applications of sensors in closed containers or beyond barriers by providing apparatus, systems and methods using precise and simple circuits for sampling an environment parameter.

As noted, existing devices use AC signals to continuously transmit power through a transformer, require complex circuitry connected to the thermistor, and/or use relatively complex strategies for conveying the intelligence from the sensor back to the source. In contrast, the present invention uses a single electric pulse of short duration for each temperature measurement. The single electric pulse measurement of the invention is very fast and does not appreciably heat the thermistor. In addition, the invention uses simpler circuitry than do existing devices.

Accordingly, an exemplary embodiment of the invention is directed to a system for measuring the temperature of an environment at one side of a barrier comprising a primary inductor disposed at a first side of the barrier, a secondary inductor disposed at a second side of the barrier, a thermistor disposed at the second side of the barrier and connected to the secondary inductor, and a first pulse generator adapted for sourcing an electric pulse to the primary inductor. The primary inductor is inductively coupled to the secondary inductor, and the thermistor has a resistance that is determined by the environment temperature at the second side of the barrier. In operation, the electric pulse causes a first current through the primary inductor that is modified by a mutually-induced second current through the secondary inductor that is further determined by the resistance of the first thermistor. Preferably, the system further comprises a measuring circuit that converts a peak current value of the first current into a temperature value representative of the environment temperature at the second side of the barrier.

In an exemplary embodiment, current on the primary side of the inductor circuit charges a capacitor, which in turn supplies a voltage to an operational amplifier (op-amp). This op-amp charges a second capacitor through a diode, thus forming a peak hold circuit. In this exemplary embodiment, the voltage on the capacitor is buffered by a second op-amp and then voltage offset compensated and gain scaled by a third op-amp. A fourth op-amp is used to supply an offset compensation voltage to the third op-amp. The output of the third op-amp is measured by an analog-to-digital converter (ADC), which may be located in a microcontroller. After the measurement is completed, the microcontroller drains the charge on second capacitor though a diode connected thereto, by placing a low pulse on the other end of the diode.

In another exemplary embodiment, a peak-hold circuit, containing a single op-amp, is connected to a microcontroller containing a digital-to-analog converter (DAC) and an offset-adjusting processing circuit.

In still other exemplary embodiments of the invention, the thermistor of the first embodiment may be replaced with any sensor, hereinafter, “sensor,” having an impedance that changes with a change in an environment parameter. Impedance hereinafter means resistance, inductance, capacitance, or any combination thereof. The sensor may be used for sensing any type of environment parameters, e.g., humidity, pressure, temperature, acidity, etc. One such exemplary embodiment of the invention is directed to a system for measuring one or more environment parameters at one side of a barrier comprising a first primary inductor adapted to be disposed at a first side of the barrier, a first secondary inductor adapted to be disposed at a second side of the barrier, a first sensor connected to the first secondary inductor, and a first pulse generator adapted for sourcing a first voltage pulse. As in the previous exemplary embodiments, the first primary inductor is inductively coupled to the first secondary inductor. The first sensor has an impedance that is determined by a first environment parameter at the second side of the barrier. In operation, the first voltage pulse causes a first current through the first primary inductor that is modified by a mutually-induced second current through the first secondary inductor that is further determined by the impedance of the first sensor. Preferably, the system further comprises a measuring circuit that converts a peak current value of the first current into a first parameter value representative of the first environment parameter at the second side of the barrier.

In order to measure additional parameters, the system may incorporate a plurality of sensors. In one such exemplary embodiment, the foregoing system further comprises one or more alternate sensor circuits, each of which comprises an alternate primary inductor adapted to be disposed at the first side of the barrier, an alternate secondary inductor adapted to be disposed at the second side of the barrier, and an alternate sensor adapted to be disposed at the second side of the barrier and connected to the alternate secondary inductor. The alternate primary inductor is inductively coupled to the alternate secondary inductor. The alternate sensor has an impedance that is determined by an alternate environment parameter at the second side of the barrier. In this exemplary embodiment, the first pulse generator is further adapted for sourcing an alternate voltage pulse to the at least one alternate primary inductor as an alternative to sourcing the first voltage pulse to the first primary inductor. The alternate voltage pulse causes an alternate current through the alternate primary inductor that is modified by a mutually-induced alternate current through the corresponding alternate secondary inductor, that is further determined by the impedance of the corresponding alternate sensor. The secondary inductors may be closely placed together, e.g., as layers of a multi-layered printed circuit board (PCB). Each combination of sensors and secondary inductors communicates with the primary inductor and measurement circuit. The primary inductor is disposed near each of the secondary inductors and is magnetically coupled thereto.

In another exemplary embodiment having a plurality of sensors, the measurement system incorporates a plurality of pairs of sensors and secondary inductors, each secondary inductor being placed in close proximity to the first primary inductor. This measurement system further comprises one or more alternate sensor circuits, the alternate sensor circuits each comprising an alternate secondary inductor adapted to be disposed at the second side of the barrier and configured such that the first primary inductor may be inductively coupled to the alternate secondary inductor. The alternate sensor circuit also includes an alternate sensor adapted to be disposed at the second side of the barrier and connected to the alternate secondary inductor. The alternate sensor has an impedance that is determined by an alternate environment parameter at the second side of the barrier.

Another exemplary embodiment is directed to a device for measuring a temperature in an environment comprising a first inductor inductively coupled to a second inductor (transformer coupling), a pulse generator configured to source a pulse of current to the first inductor, a thermistor, and means for measuring a peak voltage across the first inductor. In this embodiment, when the pulse is sourced to the first inductor, the second inductor produces a first voltage across the thermistor. The first voltage causes a change in the peak voltage across the first inductor by means of back electromotive force.

In addition to systems and devices, the present invention is also directed to methods of measuring or monitoring temperature and other environment parameters. One such method for measuring or monitoring temperature comprises the steps of: providing a primary inductor and a secondary inductor, the primary inductor inductively coupled to the secondary inductor and disposed at a first side of a barrier, and the secondary inductor disposed at a second side of the barrier; providing a thermistor responsive to a temperature at the second side of the barrier, the thermistor connected to the secondary inductor; sourcing a voltage pulse, wherein the voltage pulse causes a first current through the primary inductor that is modified by a mutually-induced second current through the secondary inductor that is further determined by the resistance of the thermistor; measuring a peak voltage value or a peak current value of the first current; and converting the measured peak current value or measured peak voltage value to a temperature value representative of the temperature at the second side of the barrier. Preferably, the step of sourcing a voltage pulse is accomplished by providing a first pulse generator, and the step of measuring is accomplished by providing a measuring circuit. The first pulse generator and the measuring circuit are disposed at the first side of the barrier and the thermistor is disposed at the second side of the barrier

Another exemplary embodiment is directed to a method for measuring at least one environment parameter on one side of a barrier comprising the steps of: providing a first primary inductor and a first secondary inductor, the first primary inductor inductively coupled to the first secondary inductor and adapted to be disposed at a first side of a barrier, and the first secondary inductor adapted to be disposed at a second side of the barrier; providing a first sensor responsive to a first environment parameter adapted to be disposed at the second side of the barrier, the first sensor connected to the first secondary inductor; sourcing a voltage pulse, wherein the voltage pulse causes a first current through the first primary inductor that is modified by a mutually-induced second current through the first secondary inductor that is further determined by the impedance of the first sensor; measuring a peak current value or a peak voltage value of the first current; and converting the measured peak current value or measured peak voltage value to a parameter value representative of the first environment parameter at the second side of the barrier.

This method may further comprise the steps of providing one or more alternate sensor circuits, the alternate sensor circuits each comprising: an alternate primary inductor adapted to be disposed at the first side of the barrier; an alternate secondary inductor adapted to be disposed at the second side of the barrier, wherein the alternate primary inductor is inductively coupled to the alternate secondary inductor; and an alternate sensor adapted to be disposed at the second side of the barrier and connected to the alternate secondary inductor, the alternate sensor having an impedance that is determined by an alternate environment parameter at the second side of the barrier. The first pulse generator is further adapted for sourcing an electric pulse to at least one of the alternate primary inductors as an alternative to sourcing the electric pulse to the first primary inductor. The electric pulse causes an alternate current through the at least one alternate primary inductor that is modified by a mutually-induced current through the corresponding alternate secondary inductor, the mutually-induced current being further determined by the impedance of the corresponding alternate sensor.

Alternately, the method may further comprise providing one or more alternate sensor circuits, the alternate sensor circuits each comprising: an alternate secondary inductor adapted to be disposed at a second side of the barrier, wherein the first primary inductor is inductively coupled to the alternate secondary inductor; and an alternate sensor adapted to be disposed at the second side of the barrier and connected to the alternate secondary inductor, the alternate sensor having an impedance that is determined by an alternate environment parameter at the second side of the barrier.

Other embodiments, features and advantages of the invention will be apparent from the following description of presently preferred embodiments, given for the purpose of disclosure and taken in conjunction with the accompanying drawings.

### BRIEF DESCRIPTION OF THE DRAWINGS

FIG. 1a is a schematic block diagram of an inductor circuit that includes a primary inductor outside a housing and a secondary inductor and a thermistor inside the housing.

FIG. 1b is a graph depicting a circuit response to a single electric pulse, in which there is no load on the secondary inductor.

FIG. 1c is a graph depicting circuit response to a single electric pulse, in which there is a thermistor loading the secondary inductor.

FIG. 2 is a schematic block diagram of a measuring circuit with a peak hold circuit, a buffer circuit, a scaling circuit, an analog to digital converter, and a circuit for resetting the peak hold circuit in preparation for a new measurement.

FIG. 3 is a schematic block diagram of an inductor circuit that includes a plurality of primary inductors outside a housing and a plurality of pairs of secondary inductors and sensors inside the housing.

FIG. 4 is a schematic block diagram of an inductor circuit that includes a primary inductor outside a barrier and a plurality of pairs of secondary inductors and sensors inside a barrier.

FIG. 5 is a plan view of a secondary inductor circuit of the embodiment illustrated in FIG. 4, in which the inductor circuit is disposed at a layer of a multi-layered printed circuit board.

FIG. 6 is an elevation view of inductor circuits of the embodiment illustrated in FIG. 4, in which the inductor circuits are disposed at adjacent layers of a multi-layered circuit board.

While the present invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to systems, devices, and methods for measuring or monitoring the temperature and other parameters at one side of a barrier using an inductively coupled thermistor or other sensor. By disposing first and second inductors on opposite sides of the barrier, measurements can be taken without having to run a wire or other electrical connection through a hole in the barrier to connect the sensor to the measurement circuit. The first and second inductors form a transformer, by electromagnetic coupling, that passively couples a sensor, e.g., a thermistor, on one side of a barrier, to a measuring circuit on the opposite side of the barrier. The present invention overcomes the problems in existing systems by making measurements from the transient response of the transformer to an electric pulse.

Referring now to the drawings, the details of preferred embodiments of the invention are schematically illustrated. Like elements in the drawings will be represented by like numbers, and similar elements will be represented by like numbers with a different lower case letter suffix.

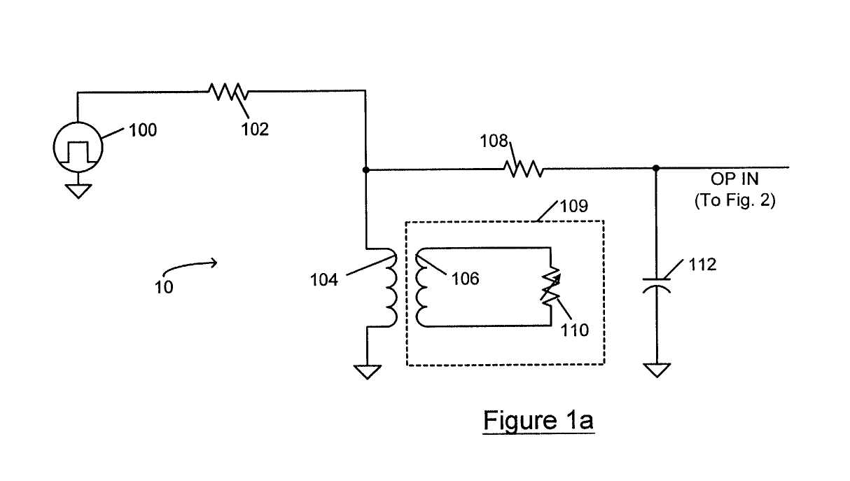

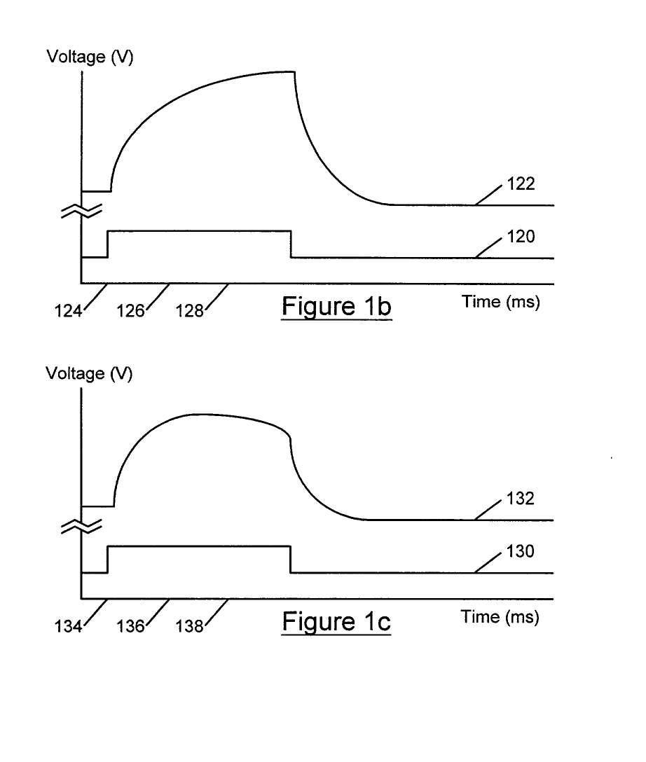

An exemplary embodiment of a system for measuring or monitoring temperature in an environment using an inductively coupled thermistor is depicted in FIGS. 1-2. Referring now to FIG. 1a, an inductor circuit, indicated generally by the numeral 10, comprises an active circuit disposed outside of a refrigerator housing 109, and a passive circuit disposed inside refrigerator housing 109. A pulse generator 100 is connected to common and a resistor 102. The pulse generator 100 may generate any kind of electric pulse, e.g., a voltage pulse. Resistor 102 is in turn connected to a resistor 108 and a primary inductor, such as primary transformer coil 104.

Primary transformer coil 104 is connected to common and coupled, via an electromagnetic field, to a secondary inductor, such as secondary transformer coil 106. Secondary transformer coil 106 is connected to thermistor 110. Transformer coils 104 and 106 are of sufficient diameter to magnetically couple through the wall of the refrigerator. For example, an appropriate coil, such as a coil comprising 100 turns of wire wound around a 12 cm diameter disk, will provide sufficient inductance and size to couple through a conventional refrigerator wall approximately ½ inch thick. In an exemplary embodiment, pulse generator 100, which may be located on a microcontroller (not shown) and may source an electric pulse to energize the primary transformer coil 104. The ratio of the coils of the primary inductor and the coils of the secondary inductor may be 1:1 or any other suitable ratio.

Resistor 108 is coupled to a capacitor 112 and to the positive input of an op-amp 200 (FIG. 2). Pulse generator 100 sources a high level voltage (e.g., 3.3 or 5 Volts) for an appropriate time duration. For example, in an exemplary embodiment, the voltage pulse has a pulse duration time of 3 microseconds. During the first microsecond of the pulse, the voltage across capacitor 112 increases from a power supply common level of voltage to approach the high level of voltage sourced by the pulse generator 100. The increase in voltage across capacitor 112 causes an increase in voltage across primary transformer coil 104, thereby inducing a proportional increase in voltage across secondary transformer coil 106 and thermistor 110.

In operation, voltage across thermistor 110 causes current to flow through thermistor 110, which, through back electromotive force (EMF), reduces the voltage across primary transformer coil 104. An increase in current through thermistor 110 causes a decrease in voltage across primary transformer coil 104. EMF is the difference in potential produced by sources of electrical energy which can be used to drive currents through external circuits. Back EMF is the EMF that opposes the normal flow of current in a circuit. Resistor 108 and capacitor 112 may, for example, form a ratio of approximately 10000:1 with the value of the primary transformer coil 104.

The reduction in voltage across the primary transformer coil 104 caused by back EMF dampens the increase in voltage across primary transformer coil 104 caused by the increase in voltage across capacitor 112, which was in turn caused by the voltage pulse from pulse generator 100. During the second microsecond of the duration of the voltage pulse from pulse generator 100, this dampening becomes evident.

During the third microsecond, the voltage across primary coil 104 may stop increasing and begin decreasing, due to the back EMF effect. The peak voltage measured across the primary coil 104, then, is lower than a peak voltage calibrated with a maximum load in place of the thermistor 110. The difference between the measured peak voltage and the calibrated peak voltage is proportional to the resistance of the thermistor 110, which in turn is proportional to the temperature of the thermistor 110.

FIG. 1b is a graph showing voltage response to a single electric pulse across a primary inductor, without a back EMF producing load. This voltage response illustrates an “RLC circuit” response to a voltage pulse applied thereto. On the x-axis representing time, a point 124 marks the beginning of the first microsecond of the pulse duration, a point 126 marks the beginning of the second microsecond of the pulse duration, and a point 128 marks the beginning of the third microsecond of the pulse duration. Trace 120 is the voltage response of the electric pulse; it is at high voltage for approximately 3 milliseconds and then low voltage (common) again. Trace 122 is the voltage response across the primary inductor. Trace 122 rises to a gentle peak when energized by the electric pulse, with no back EMF exerted by a secondary load.

In contrast, FIG. 1c is a graph showing the voltage response to a single electric pulse across the primary inductor according to the exemplary embodiments of the invention, wherein a sensor is loading the secondary inductor. This voltage response illustrates that the addition of a sensor to the inductor circuit introduces a loading effect dependent upon the sensor's impedance value. On the x-axis representing time, a point 134 marks the beginning of the first microsecond of the pulse duration, a point 136 marks the beginning of the second microsecond of the pulse duration, and a point 138 marks the beginning of the third microsecond of the pulse duration. Trace 130 is the voltage response of the electric pulse; it is at high voltage for approximately 3 milliseconds and then low voltage again. Trace 132 is the voltage response across the primary inductor. Trace 132 rises when energized by the electric pulse, but does not rise to as high a value as did trace 122 because of the sensor load.

The temperature of the thermistor 110, which is the same as the temperature of the thermistor's environment, i.e., the inside of the housing 109, is determined by using an extremely short electric pulse to probe the resistance of the thermistor. Accurate measurement of the environment inside the housing is achieved without causing resistive heating of the thermistor which could affect the accuracy of the temperature measurement.

FIG. 2 illustrates an exemplary embodiment of a measuring circuit, indicated generally by the numeral 20, for measuring a peak voltage value and for interpreting this peak voltage value as an indication of the environment parameter sensed by the inductor circuit's sensor. The positive input of op-amp 200 receives a modified electric pulse from the inductor circuit 10. The output of op-amp 200 is connected to the cathode of a diode 202. The anode of diode 202 is connected to the negative input of op-amp 200, to achieve negative feedback. The anode of diode 202 is further connected to the cathode of a diode 228, a capacitor 204, and the positive input of op-amp 206. Capacitor 204 is also connected to common. Op-amp 200 thereby implements a high-speed peak hold circuit 232 by passing current that charges capacitor 204 and not allowing capacitor 204 to discharge. Peak hold circuit 232 allows for a precise peak input voltage measurement to be made without the need for a fast analog-to-digital converter (ADC).

The anode of diode 228 is connected to pulse generator 226. Pulse generator 226, preferably located on a microcontroller 230, is connected to common. After a measurement has been made, capacitor 204 is discharged by means of a short reset pulse 226 from the microcontroller 230. Once capacitor 204 has been discharged, pulse 226 returns to a continuous high-voltage level in anticipation of another measurement being made. When pulse 226 is at a high voltage, diode 228 cannot discharge capacitor 204, thereby preserving the integrity of the measured peak voltage value.

The output of op-amp 206 is connected to a resistor 208 and the negative input of op-amp 206. Resistor 208 is connected to a resistor 210 and a positive input of an op-amp 212. Resistor 210 is connected to common. Op-amp 206 implements a buffer circuit 234 by impedance-matching capacitor 204 to the difference amplifier implemented by op-amp 212. This impedance-matching prevents the difference amplifier from “cropping” the voltage across capacitor 204, that is, from keeping it from reaching its true peak value.

The output of op-amp 212 is connected to a resistor 214, a resistor 222, and an analog-to-digital converter (ADC) 224. Resistor 222 is connected to common. Resistor 222 and ADC 224 are preferably located on the microcontroller 230. The microcontroller 230 is thereby configured to ultimately detect a change in voltage across the primary inductor due to any loading on the secondary inductor. Resistor 214 is connected to the negative input of 212 and a resistor 216, to achieve gain adjustment for op-amp 212.

The positive input of op-amp 218 is connected to the variable input of a potentiometer 220. Potentiometer 220 is, in turn, connected to Vdd and to common. The offset voltage, which is preferably 2.75 Volts in the embodiment depicted in FIG. 2, is selected by the potentiometer functioning as a voltage divider and connected to the positive input of the op-amp 218. The offset voltage from the output of the op-amp 218 is used for calibration. For example, potentiometer 220 is adjusted with the largest anticipated load on a secondary transformer coil such as secondary inductor 106. Potentiometer 220 is further adjusted until ADC 224 is no longer reading a full scale voltage. Thus, op-amp 218 implements a calibration circuit 238.

Once calibration has been achieved, any load on secondary transformer coil 106 will cause the voltage across secondary transformer coil 106 to drop. The gain is set so that the values read by the ADC vary over the entirety of the desired range of five volts. Because the peak voltage measured across a primary inductor in an exemplary embodiment may vary by approximately 500 milliVolts, op-amp 212 implements a difference amplifier 236 having a gain of 10.

The difference amplifier 236 subtracts the offset voltage supplied by calibration circuit 238 from the peak voltage supplied by op-amp 206, and multiplies the difference by an appropriate gain, e.g., a gain of 10. In this situation, the output of the difference amplifier 236 is preferably a full scale ADC voltage value between 0 and 5 Volts. Thus, the difference amplifier 236 and the calibration circuit 238 together implement a scaling and offset adjustment circuit.

Referring to Table I herein, exemplary assembly language program code that can be used to take a measurement, according to exemplary embodiments of the invention disclosed herein, for a microcontroller 230, such as a Microchip Technologies Inc., PIC 12C67x is illustrated. The slowest part of the measurement routine in this embodiment is waiting for ADC 224 to finish sampling the peak voltage. In a test system, GPIO, 4 was used to drive a light-emitting diode (LED) with a pulse width modulation (PWM) signal. This PWM signal was generated with a TMR0 interrupt. To prevent the TMR0 interrupt from affecting the pulse timing, the interrupts were disabled during the critical section of the measurement code. The microcontroller 230 operated from its internal RC oscillator. This configuration leaves other microcontroller pins available to accomplish other tasks.

TABLE I
Code Listing

| Filename: | fridge.asm |
|---|---|
| File Version: | 1.0 |

| | | | |
|---|---|---|---|
| list | p=12ce674 | ; | list directive to define processor |
| #include | <p12ce674.inc> | ; | processor specific variable |

| | | | definitions |
|---|---|---|---|
| error | −302 | ; | suppress message 302 from list file |

level

| | |
|---|---|
| _CONFIG | _CP_OFF & _WDT_OFF & _MCLRE_OFF & _PWRTE_ON & |

_INTRC_OSC_NOCLKOUT
;***** VARIABLE DEFINITIONS

| | | | | |
|---|---|---|---|---|
| w_temp | EQU | 0x70 | ; | variable used for context saving |
| status_temp | EQU | 0x71 | ; | variable used for context saving |
| tsr | EQU | 0x72 | ; | transmit shift register |
| bitcount | EQU | 0x73 | ; | transmit bit counter |
| led | EQU | 0x74 | ; | LED brightness |
| counter | EQU | 0x75 | ; | LED PWM counter |
| temp | EQU | 0x76 | ; | holding for PWM status |

;***** CONSTANTS DEFINITIONS

| | | | | |
|---|---|---|---|---|
| speed | EQU | 0xDf | ; | PWM period constant |

***** PIN DEFINITIONS

| | | | | |
|---|---|---|---|---|
| holdcap | EQU | 0x02 | ; | GPIO pin for the hold cap |
| coil | EQU | 0x01 | ; | GPIO pin for the coil |
| pwm | EQU | 0x04 | ; | GPIO pin for the pwm (LED |

| | |
|---|---|
| ; | brightness) |

;***************************************************************************

****

| ORG | 0x000 | ; | processor reset vector |
|---|---|---|---|
| goto | main | ; | go to beginning of program |
| ORG | 0x004 | ; | interrupt vector location |
| movwf | w_temp | ; | save off current W register |
| | | | contents |
| movf | STATUS,w | ; | move status register into W |
| | | | register |
| movwf | status_temp | ; | save off contents of STATUS |
| | | | register |
| incf | counter,w | ; | PWM routine |
| addwf | led,w | | |
| btfss | STATUS,C | | |
| bcf | GPIO,pwm | | |
| btfsc | STATUS,C | | |
| bsf | GPIO,pwm | | |
| movwf | counter | | |
| bcf | INTCON,T0IF | ; | clear the TMR0 flag |
| bsf | INTCON,T0IE | ; | reenable TMR0 interrupt |
| movlw | speed | | |
| movwf | TMR0 | | |
| movf | status_temp,w | ; | retrieve copy of STATUS register |
| movwf | STATUS | ; | restore pre-isr STATUS register |

| | |
|---|---|
| ; | contents |

| | | | |
|---|---|---|---|
| movf | w_temp,w | ; | restore W register |
| retfie | | ; | return from interrupt |

main

| | | | |
|---|---|---|---|
| call | 0x7FF | ; | retrieve factory calibration value |
| bsf | STATUS,RP0 | ; | set file register bank to 1 |
| movwf | OSCCAL | ; | update register with factory cal |
| | | | value |
| bcf | STATUS,RP0 | ; | set file register bank to 0 |
| clrf | TMR0 | ; | clear the timer |
| clrf | counter | | |
| clrf | led | | |

;setup GPIO

| | | | |
|---|---|---|---|
| clrf | GPIO | ; | set all I/O's to 0 |
| clrf | INTCON | ; | clear all flags and enables |
| bsf | INTCON,T0IE | ; | enable TMR0 interrupt |
| bsf | INTCON,GIE | ; | enable all interrupts |
| bsf | STATUS,RPO | ; | Select Page 1 |
| clrf | OPTION_REG | ; | clear all options |

| | | | |
|---|---|---|---|
| bsf | OPTION_REG,NOT_GPPU | ; | Turn off weak pull-up |

| | movlw | B‘00001001’ | ; | GPIO 0 is Input |
|---|---|---|---|---|
| | | | ; | GPIO 1 is Output |
| | | | ; | GPIO 2 is Output |
| | | | ; | GPIO 3 is Input |
| | | | ; | GPIO 4 is Output |
| | | | ; | GPIO 5 is Output |
| | movlw | TRISIO | | |
| | movlw | B‘00000110’ | ; | GPO is analog, VREF is Vdd |
| | movwf | ADCON1 | ; | Configure A/D Inputs |
| | bcf | PIE1,ADIE | ; | disable A/D Interrupts |
| | bcf | STATUS,RP0 | ; | Select Page 0 |
| | movlw | B‘01000001’ | ; | 8 Tosc clock, A/D is on, Channel 0 |
| | | | ; | is selected |
| | movwf | ADCONC0 | ; | |
| | bcf | PIR1,ADIF | ; | Clear AID interrupt flag bit |
| repeat | call | measure | ; | make a measurement |
| | movwf | led | ; | set the LED brightness |
| | movlw | D‘56’ | ; | wait 200 loops or lms |
| delay | nop | | ; | |
| | addlw | D‘1’ | ; | |
| | btfss | STATUS,Z | ; | |
| | goto | delay | ; | |
| | goto | repeat | | |
| measure | ; measurement routine | | | |
| | bcf | INTCON,GIE | ; | disable all interrupts |
| | bsf | GPIO,holdcap | ; | arm capacitor 204 |
| | bsf | GPIO,coil | ; | charge a primary inductor coil |
| | nop | | ; | pause |
| | bcf | GPIO,coil | ; | turn off coil 204 |
| | nop | | ; | wait for the inductor collapse to |
| | | | | finish |
| | bsf | ADCON0,GO | ; | start ADC 224 |
| | btfsc | ADCON0,GO | ; | wait for ADC 224 to finish |
| | goto | $-1 | ; | go back if not finished yet |
| | bcf | GPIO,holdcap | ; | drain capacitor 204 |
| | bsf | INTCON,GIE | ; | enable all interrupts |
| | movf | ADRES,W | ; | move the result to address W |
| | return | | ; | measurement routine finished |
| | END | | | |

In an exemplary embodiment, the buffer implemented by op-amp 206, the difference amplifier implemented by op-amp 212, and the offset voltage from op-amp 218 may be eliminated from the measuring circuit. Instead, ADC 224, programmed to perform the functions of the eliminated components, is then connected directly to capacitor 204. This embodiment provides the additional advantages of even simpler circuitry and reduced cost.

In another exemplary embodiment, with minor modifications to the microcontroller software, diode 228 may be replaced with a direct connection to a microcontroller pin 240 if the pin 240 is left as an input pin at high impedance until capacitor 204 needs discharging, that is, until after a measurement is made.

In yet another exemplary embodiment, diode 228 may be replaced with a suitable load resistor (not shown) provided for capacitor 204. The resistor is large enough so that capacitor 204 does not drain too much charge during a measurement and also is small enough to drain much of the charge from capacitor 204 between measurements, when a low voltage electric pulse is sourced by pulse generator 226.

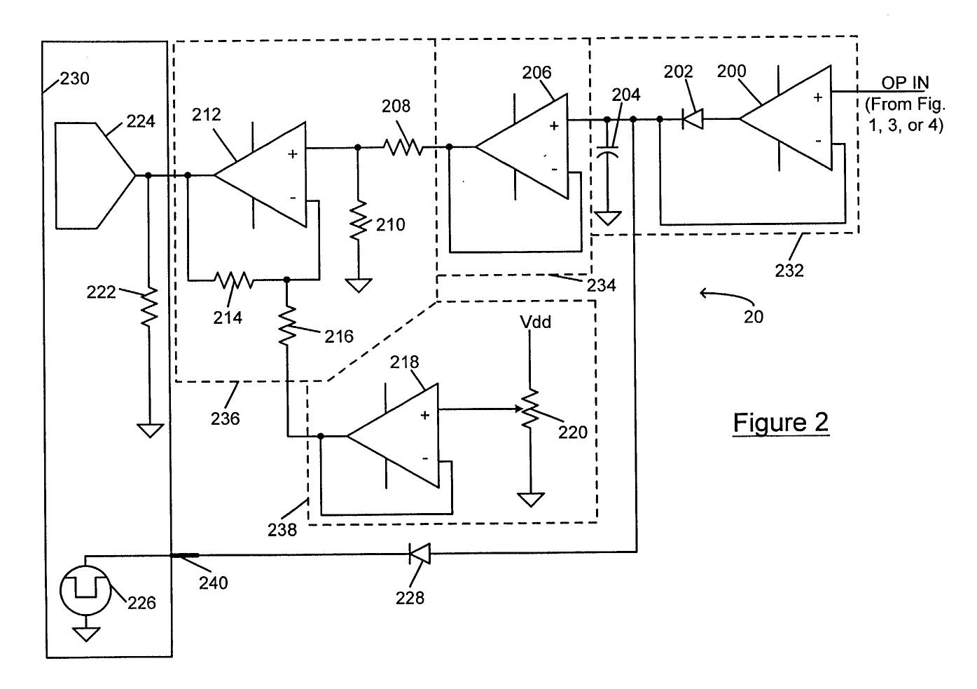

The present invention also includes systems for measuring or monitoring parameters other than temperature and for monitoring more than a single environment parameter. For example, FIG. 3 depicts an alternate exemplary embodiment of an inductor circuit, indicated generally at 3 , comprising an active circuit outside of a barrier 309 and a passive circuit(s) inside the barrier 309. A pulse generator 300 is connected to common and a resistor 302. Resistor 302 is in turn connected to a resistor 308 and a switch 303. Switch 303 is connected to a plurality of primary transformer coils 304, 313, and 317.

Primary transformer coil 304 is connected to the switch 303 and common, and coupled, via an electromagnetic field, to a secondary transformer coil 306. Secondary transformer coil 306 is connected to sensor 310. Sensor 310 may be a thermistor or any other type of impeding sensor.

A second primary transformer coil 313 is connected to the switch 303 and common, and coupled, via an electromagnetic field, to a second secondary transformer coil 314. Secondary transformer coil 314 is connected to sensor 316.

Optionally, a third primary transformer coil 317 is connected to the switch 303 and common, and coupled, via an electromagnetic field, to a third secondary transformer coil 318. Secondary transformer coil 318 is connected to sensor 320. As will be clear to those of ordinary skill in the pertinent art and having the benefit of this disclosure, the total number of transformers and the total number and type of sensors may be varied as desired to measure a variety of different environment parameters, such as humidity, pressure, temperature, and acidity. The locations at which the transformers and the sensors are disposed may also be varied.

Referring again to FIG. 3, transformer coils 304, 306, 313, 314, 317, and 318 are of sufficient diameter to effectively magnetically couple through the wall of the enclosure. For instance, an appropriate coil, such as a coil comprising 100 turns of wire wound around a 12 cm diameter disk, will provide sufficient inductance and size to couple through a wall approximately ½ inch thick.

A pulse generator, located on a microcontroller (not shown), sources an electric pulse 300 to energize any one of primary transformer coils 304, 313, or 317.

Resistor 308 is coupled to a capacitor 312 and to the positive input of op-amp 200 (FIG. 2).

As will be clear to those of ordinary skill in the pertinent art and having the benefit of this disclosure, the sensors may be responsive to the same or different environment parameters, i.e., the first and alternate environment parameters may be the same or different.

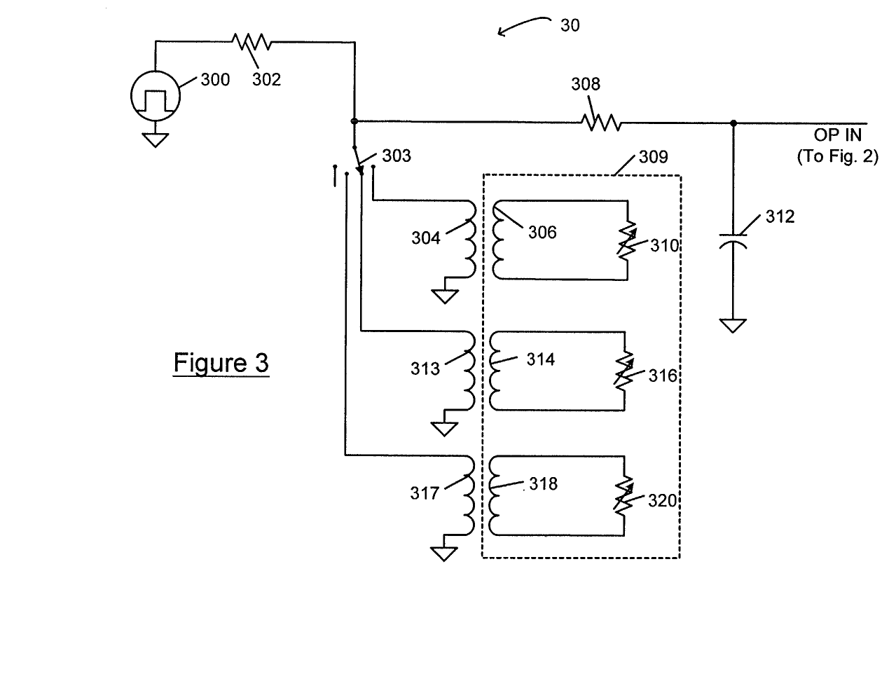

Still another exemplary embodiment of the invention useful for measuring a plurality of different parameters is depicted in FIG. 4. Specifically, FIG. 4 depicts an inductor circuit, indicated generally at 40, comprising an active circuit outside of a barrier 430, and a passive circuit inside the barrier 430. A pulse generator 400 is connected to common and a resistor 402. Resistor 402 is in turn connected to a resistor 408 and a primary transformer coil 404. Primary transformer coil 404 is connected to common and coupled, via an electromagnetic field, to a plurality of secondary transformer coils, e.g., secondary transformer coils 406, 414, and 418, corresponding to a first, second, and third resonant frequencies.

To form a series resonant circuit tuned to the first frequency, secondary transformer coil 406 is connected to a capacitor 409 and common. Capacitor 409 is connected to sensor 410. To form a series resonant circuit tuned to the second frequency, secondary transformer coil 414 is connected to a capacitor 415 and common. Capacitor 415 is connected to sensor 416. To form a series resonant circuit tuned to the third frequency, secondary transformer coil 418 is connected to a capacitor 419 and common. Capacitor 419 is connected to sensor 420. As with the previous embodiment, the number of secondary transformer coils and the number and type of impeding sensors may be varied depending on the desired application.

Transformer coils 404, 406, 414, and 418 are of sufficient diameter to effectively magnetically couple through the wall or barrier of interest. For instance, an appropriate coil comprising 100 turns of wire wound around a 12 cm diameter disk will provide sufficient inductance and size to couple through a wall approximately ½ inch thick.

A pulse generator, located on a microcontroller (not shown), preferably sources as much current as 25 milliamperes in order to energize primary transformer coil 404.

To form a parallel resonant circuit tunable to the frequencies of the first, second, and third series resonant circuits, resistor 408 is connected to the positive input of an op-amp, (e.g., op-amp 200, FIG. 2) and to capacitors 422, 424, and 426. Capacitors 422, 424, and 426, respectively select the first, second, and third resonant frequencies, through switch 428, which in turn is connected to common.

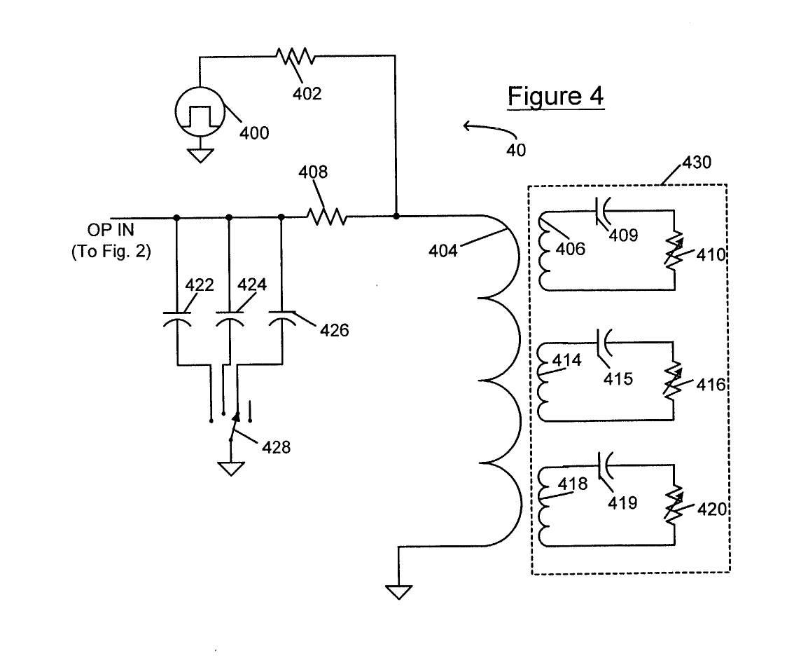

Shown in FIG. 5 is a plan view of a multi-layered printed circuit board (PCB) for implementation of the exemplary embodiment of the inductor circuit shown in FIG. 4. Secondary transformer coil 418 is connected to capacitor 419 and jumper cable 500. Jumper cable 500 is connected to common. Capacitor 419 is connected to potentiometer 420, which in turn is connected to common. This plan view reveals the partial contents of one layer of the PCB.

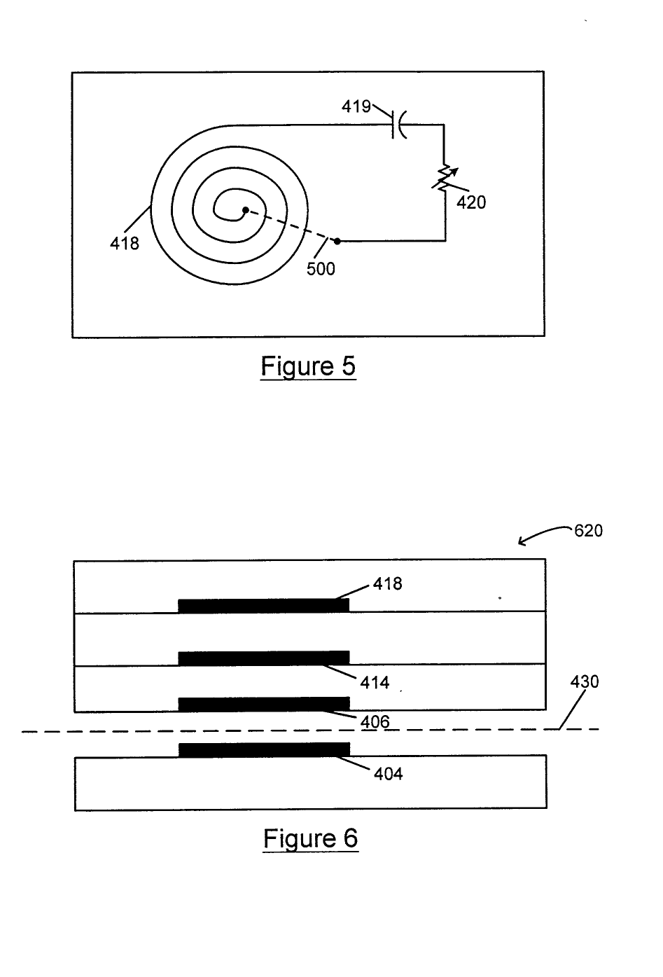

Shown in FIG. 6 is an elevation view of the multi-layered PCB 620 implementation of the exemplary embodiment of the inductor circuit shown in FIG. 4. Secondary transformer coils 418, 414, and 406 are disposed on adjacent layers of the PCB 620. The greatest distance between mutually coupled coils, that is, the distance between coil 418 and 404, is preferably less than 1 inch, ensuring that the mutual coupling is feasible.

As will be clear to those of ordinary skill in the pertinent art and having the benefit of this disclosure, the foregoing exemplary embodiments may be used to measure one or more parameters in any type of remote environment, e.g., inside a refrigerator or other enclosure, beyond any type of barrier, a hazardous gas environment, a liquid, a solid, a vacuum, a low pressure environment, a high pressure environment, a humid environment, or a dry environment. If desired, the present invention may be modified, for example, to allow measurements inside the body of a human or animal. The sensors and secondary inductors may be disposed in portable or ingestible devices. For example, the secondary inductors and sensors may be adapted to be disposed inside the body. In other words, they may be configured so that they may be ingested or implanted, allowing for measurements of parameters inside the digestive tract or elsewhere in the body. The inductors and sensors may be digestible or otherwise biodegradable, or may be biostable and pass through the digestive system or remain where implanted without degradation.

Illustrative exemplary embodiments of the invention are described herein. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

The invention, therefore, is well adapted to carry out the objects and attain the ends and advantages mentioned, as well as others inherent therein. While the invention has been depicted, described, and is defined by reference to particular preferred embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described preferred embodiments of the invention are exemplary only, and are not exhaustive of the scope of the invention. Consequently, the invention is intended to be limited only by the spirit and scope of the appended claims, giving full cognizance to equivalents in all respects.

We claim:

1. A system for measuring a temperature of an environment at one side of a barrier comprising:
a primary inductor disposed at a first side of the barrier;
a secondary inductor disposed at a second side of the barrier, wherein the primary inductor is inductively coupled to the secondary inductor;
a thermistor disposed at the second side of the barrier and connected to the secondary inductor, the thermistor having a resistance that is determined by the environment temperature at the second side of the barrier; and
a first pulse generator adapted for sourcing an electric pulse, wherein the electric pulse causes a first current through the primary inductor that is modified by a mutually-induced second current through the secondary inductor that is further determined by the resistance of the thermistor.

2. The system of claim 1, further comprising a measuring circuit that converts a peak current value of the first current into a temperature value representative of the environment temperature at the second side of the barrier.

3. The system of claim 2, wherein the measuring circuit measures a peak voltage value proportional to the peak current value and converts the peak voltage value into a temperature value representative of the environment temperature at the second side of the barrier.

4. The system of claim 2, wherein the first pulse generator and the measuring circuit are disposed at the first side of the barrier and the thermistor is disposed at the second side of the barrier.

5. The system of claim 2, wherein the environment comprises the inside of a refrigerator housing, the primary inductor, the first pulse generator and the measuring circuit are disposed outside the refrigerator housing, and the secondary inductor and the thermistor are disposed inside the refrigerator housing.

6. The system of claim 2, wherein the environment comprises a hazardous gas environment.

7. The system of claim 2, wherein the measuring circuit comprises:
a peak hold circuit connected to the primary inductor, comprising a capacitor connected to an operational amplifier via a first diode, such that the operational amplifier charges the capacitor through the first diode;
a buffer circuit connected to the capacitor for buffering the voltage supplied by the capacitor by impedance matching the capacitor to a difference amplifier circuit;
a scaling circuit, comprising the difference amplifier circuit, connected to the buffer circuit for scaling the buffered voltage; and
an analog to digital converter connected to the scaling circuit for measuring the scaled voltage from the scaling circuit.

8. The system of claim 7, wherein the scaling circuit further comprises a calibration circuit connected to the difference amplifier circuit for supplying a calibrated offset voltage to the difference amplifier circuit.

9. The system of claim 8, further comprising means for resetting the measuring circuit by draining the capacitor.

10. The system of claim 2, wherein the measuring circuit comprises:
a peak hold circuit connected to the primary inductor, comprising a capacitor connected to an operational amplifier via a first diode, such that the operational amplifier charges the capacitor through the first diode; and
an analog to digital converter coupled to the capacitor for processing a voltage measured across the capacitor for comparison with a calibrated reference voltage.

11. The system of claim 10, further comprising means for resetting the measuring circuit by discharging the capacitor.

12. The system of claim 10, wherein the first pulse generator is configured to send a pulse to the primary inductor, and wherein a second pulse generator is configured to drain a charge stored in the capacitor through a diode disposed between the second pulse generator and the capacitor by sourcing a pulse of low voltage.

13. The system of claim 10, wherein the first pulse generator is disposed on a microcontroller, and said microcontroller is configured to cause the first pulse generator to send a pulse to the primary inductor, and wherein a second pulse generator is disposed on said microcontroller, and said microcontroller is further configured to drain a charge stored in the capacitor through a diode disposed between the second pulse generator and the capacitor by sourcing a pulse of low voltage.

14. The system of claim 10, wherein the analog to digital converter is disposed on a microcontroller.

15. The system of claim 10, wherein the first pulse generator is disposed on a microcontroller, and said microcontroller is configured to cause the first pulse generator to send a pulse to the primary inductor, and wherein a second pulse generator is disposed on said microcontroller, and said microcontroller is further configured to drain a charge stored in the capacitor into the second pulse generator by leaving an input pin connected to the second pulse generator at high impedance until the first capacitor needs discharging, at which point the input pin is changed to low impedance.

16. The system of claim 10, wherein the first pulse generator is configured to send a pulse to the primary inductor, and wherein a second pulse generator is configured to drain a charge stored in the capacitor through a resistor disposed between the second pulse generator and the capacitor by sourcing a pulse of low voltage.

17. The system of claim 10, wherein the first pulse generator is disposed on a microcontroller, and said microcontroller is configured to cause the first pulse generator to send a pulse to the primary inductor, and wherein a second pulse generator is disposed on said microcontroller, and said microcontroller is further configured to drain a charge stored in the capacitor through a resistor disposed between the second pulse generator and the capacitor by sourcing a pulse of low voltage.

18. A system for measuring at least one environment parameter at one side of a barrier comprising:
a first primary inductor adapted to be disposed at a first side of the barrier;
a first secondary inductor adapted to be disposed at a second side of the barrier, wherein the first primary inductor is inductively coupled to the first secondary inductor;
a first sensor connected to the first secondary inductor, the first sensor having an impedance that is determined by a first environment parameter at the second side of the barrier; and
a first pulse generator adapted for sourcing a first voltage pulse, wherein the first voltage pulse causes a first current through the first primary inductor that is modified by a mutually-induced second current through the first secondary inductor that is further determined by the impedance of the first sensor.

19. The system of claim 18, further comprising a measuring circuit that converts a peak current value of the first current into a first parameter value representative of the first environment parameter at the second side of the barrier.

20. The system of claim 19, wherein the measuring circuit measures a peak voltage value proportional to the peak current value and converts the peak voltage value into a first parameter value representative of the first environment parameter at the second side of the barrier.

21. The system of claim 18, wherein the first sensor has an impedance which changes with a change in the first environment parameter.

22. The system of claim 18, wherein the first environment parameter is selected from the group consisting of humidity, pressure, temperature, and acidity.

23. The system of claim 18, wherein the first sensor and the first secondary inductor are disposed in a portable device.

24. The system of claim 18, wherein the first sensor and first secondary inductor are disposed in an ingestible device.

25. The system of claim 18, wherein the first sensor and first secondary inductor are disposed in a biodegradable device.

26. The system of claim 18, further comprising one or more alternate sensor circuits, said alternate sensor circuits each comprising:
an alternate primary inductor adapted to be disposed at the first side of the barrier;
an alternate secondary inductor adapted to be disposed at the second side of the barrier, wherein the alternate primary inductor is inductively coupled to the alternate secondary inductor;
an alternate sensor adapted to be disposed at the second side of the barrier and connected to the alternate secondary inductor, the alternate sensor having an impedance that is determined by an alternate environment parameter at the second side of the barrier; and
wherein the first pulse generator is further adapted for sourcing an alternate voltage pulse to at least one of the alternate primary inductors as an alternative to sourcing the first voltage pulse to the first primary inductor, and wherein the alternate voltage pulse causes an alternate current through the at least one alternate primary inductor that is modified by a mutually-induced alternate current through the corresponding alternate secondary inductor, that is further determined by the impedance of the corresponding alternate sensor.

27. The system of claim 18, wherein the first environment parameter and alternate environment parameter are the same.

28. The system of claim 18, further comprising one or more alternate sensor circuits, said alternate sensor circuits each comprising:
an alternate secondary inductor adapted to be disposed at a second side of the barrier, wherein the first primary inductor is inductively coupled to the alternate secondary inductor; and
an alternate sensor adapted to be disposed at the second side of the barrier and connected to the alternate secondary inductor, the alternate sensor having an impedance that is determined by an alternate environment parameter at the second side of the barrier.

29. The system of claim 28, wherein the first primary inductor and first sensor and the alternate secondary inductors and alternate sensors are disposed at adjacent, different layers of a multi-layered printed circuit board.

30. The system of claim 28, wherein the first environment parameter and alternate environment parameter are the same.

31. The system of claim 2, wherein the environment comprises a liquid.

32. The system of claim 2, wherein the environment comprises a solid.

33. The system of claim 2, wherein the environment comprises a vacuum.

34. The system of claim 2, wherein the environment comprises a low pressure environment.

35. The system of claim 2, wherein the environment comprises a high pressure environment.

36. The system of claim 2, wherein the environment comprises a humid environment.

37. The system of claim 2, wherein the environment comprises a dry environment.

38. A device for measuring a temperature in an environment comprising:
a transformer comprising a first inductor inductively coupled to a second inductor;
a pulse generator configured to source a pulse of current to the first inductor;
a thermistor, wherein when the pulse is sourced to the first inductor, the second inductor produces a first voltage across the thermistor, and wherein the first voltage causes a change in the peak voltage across the first inductor by means of back electromotive force; and
means for measuring the peak voltage across the first inductor.

39. The device of claim 38, wherein the second inductor and first inductor are separated by a barrier, the first inductor is disposed at a first side of the barrier and the second inductor is disposed at a second side of the barrier, and the temperature being measured is disposed at the second side of the barrier.

40. A method for measuring temperature, comprising:
providing a primary inductor and a secondary inductor, the primary inductor inductively coupled to the secondary inductor and disposed at a first side of a barrier, and the secondary inductor disposed at a second side of the barrier;
providing a thermistor responsive to a temperature at the second side of the barrier, said thermistor connected to the secondary inductor;
sourcing a voltage pulse, wherein the voltage pulse causes a first current through the primary inductor that is modified by a mutually-induced second current through the secondary inductor that is further determined by the resistance of the thermistor;
measuring a peak voltage value or a peak current value of the first current; and
converting the measured peak current value or measured peak voltage value to a temperature value representative of the temperature at the second side of the barrier.

41. The method of claim 40, wherein the step of sourcing a voltage pulse is accomplished by providing a first pulse generator, and the step of measuring is accomplished by providing a measuring circuit, and wherein the first pulse generator and the measuring circuit are disposed at the first side of the barrier and the thermistor is disposed at the second side of the barrier.

42. The method of claim 41, wherein the barrier comprises a refrigerator housing and the second side of the barrier comprises the inside of the refrigerator housing, and wherein the primary inductor, the first pulse generator and the measuring circuit are disposed outside the refrigerator housing, and the secondary inductor and the thermistor are disposed inside the refrigerator housing.

43. The method of claim 40, wherein the second side of the barrier comprises a hazardous gas environment.

44. The method of claim 41, wherein the measuring circuit comprises:
a peak hold circuit connected to the primary inductor, comprising a capacitor connected to an operational amplifier via a first diode, such that the operational amplifier charges the capacitor through the first diode;
a buffer circuit connected to the capacitor for buffering the voltage supplied by the capacitor by impedance matching the capacitor to a difference amplifier circuit;
a scaling circuit, comprising the difference amplifier circuit, connected to the buffer circuit for scaling the buffered voltage; and
an analog to digital converter connected to the scaling circuit for measuring the scaled voltage from the scaling circuit.

45. The method of claim 44, wherein the scaling circuit further comprises:
a calibration circuit connected to the difference amplifier circuit for supplying a calibrated offset voltage to the difference amplifier circuit.

46. The method of claim 45, further comprising providing means for resetting the measuring circuit by discharging the capacitor.

47. The method of claim 41, wherein the measuring circuit comprises:
a peak hold circuit connected to the primary inductor, comprising a capacitor connected to an operational amplifier via a first diode, such that the operational amplifier charges the capacitor through the first diode; and
an analog to digital converter coupled to the capacitor for processing a voltage measured across the capacitor for comparison with a calibrated reference voltage.

48. The method of claim 47, further comprising providing means for resetting the measuring circuit by draining the capacitor.

49. The method of claim 47, wherein the first pulse generator is configured to send a pulse to the primary inductor, and wherein a second pulse generator is configured to drain a charge stored in the first capacitor through a diode disposed between the second pulse generator and the first capacitor by sourcing a pulse of low voltage.

50. The method of claim 47, wherein the first pulse generator is disposed on a microcontroller, and said microcontroller is configured to cause the first pulse generator to send a pulse to the primary inductor, and wherein a second pulse generator is disposed on said microcontroller, and said microcontroller is further configured to drain a charge stored in the first capacitor through a diode disposed between the second pulse generator and the first capacitor.

51. The method of claim 47, wherein the analog to digital converter is disposed on a microcontroller.

52. A method for measuring at least one environment parameter on one side of a barrier, comprising:
providing a first primary inductor and a first secondary inductor, the first primary inductor inductively coupled to the first secondary inductor and adapted to be disposed at a first side of a barrier, and the first secondary inductor adapted to be disposed at a second side of the barrier;
providing a first sensor responsive to a first environment parameter adapted to be disposed at the second side of the barrier, said first sensor connected to the first secondary inductor;
sourcing a voltage pulse, wherein the voltage pulse causes a first current through the first primary inductor that is modified by a mutually-induced second current through the first secondary inductor that is further determined by the impedance of the first sensor;
measuring a peak current value or a peak voltage value of the first current; and
converting the measured peak current value or measured peak voltage value to a parameter value representative of the first environment parameter at the second side of the barrier.

53. The method of claim 52, wherein the first sensor has an impedance which changes with a change in the first environment parameter.

54. The method of claim 52, wherein the first environment parameter is selected from the group consisting of humidity, pressure, temperature, and acidity.

55. The method of claim 52, wherein the first sensor and first secondary inductor are disposed in a portable device.

56. The method of claim 52, wherein the first sensor and first secondary inductor are disposed in an ingestible device.

57. The method of claim 52, wherein the first sensor and first secondary inductor are disposed in a biodegradable device.

58. The method of claim 52, further comprising providing one or more alternate sensor circuits, said alternate sensor circuits each comprising;
an alternate primary inductor adapted to be disposed at the first side of the barrier;
an alternate secondary inductor adapted to be disposed at the second side of the barrier, wherein the alternate primary inductor is inductively coupled to the alternate secondary inductor;
an alternate sensor adapted to be disposed at the second side of the barrier and connected to the alternate secondary inductor, the alternate sensor having an impedance that is determined by an alternate environment parameter at the second side of the barrier; and
wherein the first pulse generator is further adapted for sourcing an electric pulse to at least one of the alternate primary inductors as an alternative to sourcing the electric pulse to the first primary inductor, and wherein the electric pulse causes an alternate current through the at least one alternate primary inductor that is modified by a mutually-induced current through the corresponding alternate secondary inductor, said mutually-induced current being further determined by the impedance of the corresponding alternate sensor.

59. The method of claim 58, wherein the first environment parameter and the alternate environment parameter are the same.

60. The method of claim 52, further comprising providing one or more alternate sensor circuits, said alternate sensor circuits each comprising:
an alternate secondary inductor adapted to be disposed at a second side of the barrier, wherein the first primary inductor is inductively coupled to the alternate secondary inductor; and
an alternate sensor adapted to be disposed at the second side of the barrier and connected to the alternate secondary inductor, the alternate sensor having an impedance that is determined by an alternate environment parameter at the second side of the barrier.
